(19) United States
(12) Patent Application Publication
(10) Pub. No.: US 2014/0297107 A1
(43) Pub. Date: Oct. 2, 2014

(54) PARKING ASSISTANCE SYSTEM AND METHOD

(71) Applicant: GM GLOBAL TECHNOLOGY OPERATIONS LLC, Detroit, MI (US)

(72) Inventors: Oliver Wagner, Gross-Gerau (DE); Stefan Bauer, Wiesbaden (DE)

(73) Assignee: GM GLOBAL TECHNOLOGY OPERATIONS LLC, Detroit, MI (US)

(21) Appl. No.: 14/223,843

(22) Filed: Mar. 24, 2014

(30) Foreign Application Priority Data
Mar. 23, 2013 (DE) 102013005102.9

(51) Int. Cl. B60W 30/06

(52) U.S. Cl. CPC B60W 30/06
USPC 701/36

(57) ABSTRACT

A parking assistance system for a vehicle is disclosed. The system is configured to detect an empty space adjacent to a vehicle, assess the suitability of the empty space as a parking space for the vehicle and estimate the distance of the empty space from an intersection or junction. The system includes a camera coupled with a programmed processer.

### CROSS REFERENCE TO RELATED APPLICATION

This application claims priority to German Patent Application No. 102013005102.9 filed Mar. 23, 2014, which is hereby incorporated by reference in its entirety.

### TECHNICAL FIELD

The present disclosure relates to a parking assistance system for a vehicle and a method for operating such a parking assistance system.

### BACKGROUND

Parking assistance systems in vehicles are known per se and generally include environment sensors for detecting an empty space adjacent to the vehicle, and means, such as a microcomputer, for assessing the suitability of the empty space as a parking space for the vehicle on the basis of an estimate of the size of the empty space obtained with the aid of the environmental sensors.

A parking assistance system which invokes only the dimensions of an empty space in assessing its suitability as a parking space will often also treat empty spaces which are completely unsuited for parking for traffic-related reasons as parking suitable spaces. These include such things as roads extending at right angles to the road being traversed by the vehicle, for example at a junction or intersection, gaps between vehicles on an adjacent traffic lane of a multi-lane road, etc.

DE 10 2009 005 506 A1 discloses a parking assistance system and a method for operating it, which at least rejects the identification of intersecting roads as possible parking spaces, by using information from a navigation system.

Current navigation systems based on GPS allow a position determination with an accuracy of 15 m to 20 m. This lack of precision must be taken into account in assessing whether an available empty space which has been found belongs to an intersecting road or not, with the consequence that empty spaces which are in fact suitable as parking spaces are not detected as such, if their distance from an intersection or junction is less than the measurement accuracy of the navigation system. For example, the German Road Traffic Regulations allow parking at a distance of 5 m from a junction or intersection.

A parking assistance system based on GPS positioning, however, is not capable of distinguishing reliably between empty spaces located close to an intersection or junction but which satisfy the required separation distance under the road traffic regulations, and intersecting roads. Therefore, in order not to mislead drivers into illegal parking, it must not indicate such areas as parking spaces. The object of the disclosure is to create a parking assistance system which allows the reliable distinction between empty spaces which are appropriate and inappropriate for parking, even when they are very close to an intersection or junction.

### SUMMARY

According to one configuration of the present disclosure a parking assistance system for a vehicle is disclosed having means for detecting an empty space adjacent to the vehicle, means for assessing the suitability of the empty space as a parking space for the vehicle and means for estimating the distance of the empty space from an intersection or junction. The means for estimating the distance include a camera.

Such a camera, as a component part of driver assistance systems, for example for monitoring the distance from other road users, for automatic detection of traffic signs or the like, forms part of the optional equipment of many modern vehicles and can also be used in the parking assistance system according to the present disclosure without incurring any significant additional costs.

In addition, the means for estimating the distance also advantageously include an image analysis unit for identifying a traffic sign indicating an intersection or junction, and for estimating the distance between the vehicle and traffic signs. Image analysis algorithms which are suitable for such an identification are also known from assistance systems for automatic traffic sign recognition, and can also be made available without any appreciable costs for the parking assistance system according to the disclosure.

Since the size of the traffic signs to be detected is standardized, an estimate of the distance can be based on the size of the image of such a traffic sign in an image supplied by the camera. Relevant examples of indicative traffic signs which should be recognized by the image analysis unit are in particular a traffic light, a Right of Way or Yield sign.

Because when parallel parking into a parking space adjacent to an intersection or junction it may be necessary to have the vehicle approach closer to the intersection or junction than is allowed for parking, the parking assistance system can advantageously include a warning signal emitter, which provides a warning signal whenever the distance of the vehicle from the intersection or junction is less than the regulation minimum distance.

According to another configuration of the present disclosure, the object is achieved by a method for assessing the suitability of an empty space as a parking space for a vehicle with the following steps: (a) estimating the distance of the empty space from an intersection or junction with the aid of a camera; and (b) rejecting the identified empty space as unsuitable for parking if the estimated distance differs from 0, but is below a predefined limit.

In particular, a traffic sign indicating an intersection or junction can be detected using the camera, and the distance from the empty space to the traffic sign estimated, which is assumed to be the distance of the empty space from an intersection or junction marked by the traffic sign. During the parallel parking maneuver the distance of the vehicle from the intersection or junction can be monitored and a warning signal generated whenever this is less than the limit.

According to a further configuration the object is achieved by a computer program product that includes instructions which when executed on a computer, enable this computer to carry out the method described above. The subject matter of the present disclosure can also include a machine-readable data carrier such as a non-transitory computer readable medium, on which are recorded program instructions which enable a computer to carry out the method described above.

A further object of the present disclosure is a device for assessing the suitability of an empty space as a parking space for a vehicle with means for estimating the distance of the empty space from an intersection or junction with the aid of a camera; and means for rejecting the identified empty space as unsuitable for parking if the estimated distance differs from 0, but is below a predefined limit. Such a device can be formed in particular by a computer, on which the above-mentioned computer program is executed. The means for estimating the distance further include image analysis means for detecting a traffic sign indicating an intersection or junction and for estimating the distance between the vehicle and the traffic sign. The image analysis means are configured to detect as an indicative traffic sign at least such items as a traffic light, a Right of Way or Yield sign, or a stop line. The device further includes warning signal means for generating a warning signal if the estimated distance is below a limit value.

### BRIEF DESCRIPTION OF THE DRAWINGS

The present disclosure hereinafter will be described in conjunction with the following drawing figures, wherein like numerals denote like elements, and:

FIG. 1 is a vehicle equipped with a rear parking assistance system in a typical application scenario;

FIG. 2 is a block diagram of the parking assistance system; and

FIG. 3 is a flowchart of an operating procedure carried out by a processor of the parking assistance system.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

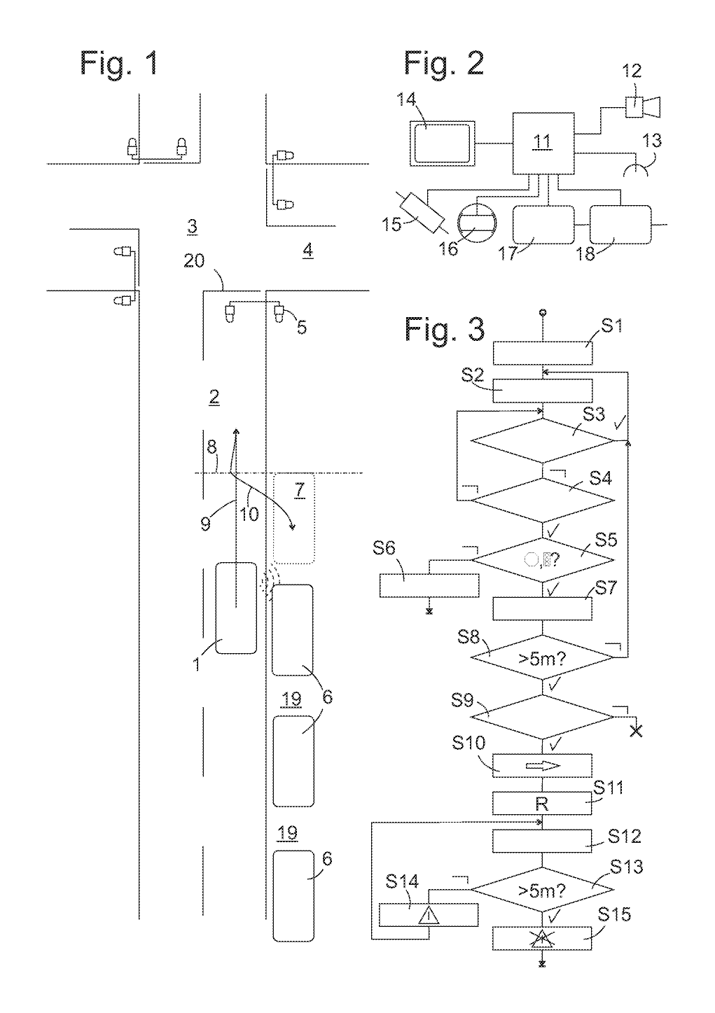

FIG. 1 shows a typical application scenario of a parking assistance system. A vehicle 1 equipped with the rear parking assistance system moves along a road 2 in the direction of an intersection 3 or junction with a cross street 4, searching for a parking space. The intersection 3 is controlled by a traffic light 5. Numerous parking spaces along the road 2 have already been occupied by other vehicles 6. Before the traffic light 5 at the side of the street 2 an empty space 7 is available, but for which it is not certain a priori, whether or not it is suitable as a parking space. Legal regulations, such as the German road Traffic Regulations, prohibit the parking of a vehicle at a distance of less than 5 m from an intersection. Even if part of the empty space 7 is located more than 5 m from the intersection, it could be unsuitable for parking if the vehicle 1 does not fit completely into the part of the empty space 7 which, viewed from the intersection 4, lies beyond the 5 m limit (indicated in FIG. 1 by a dotted and dashed line 8).

If the empty space 7 allows room to park, the driver (or, depending on the stage of development of the parking assistance system, possibly the system itself if it receives the command to do so from the driver), will parallel park the vehicle 1, by first, as indicated by an arrow 9, driving the vehicle 1 past the desired parking space, and then, corresponding to an arrow 10, reversing it into the parking space.

FIG. 2 shows a block diagram of the parking assistance system. A central processing unit or processor 11, in general, a microcomputer, is connected to a camera 12 which is oriented along the road in front of the vehicle 1. The camera 12 is typically mounted in the passenger compartment of the vehicle between the front windscreen and rear-view mirror, and to an environmental sensor 13 for detecting objects to the side of the vehicle 1. The environmental sensor 13 can be a radar sensor, which at the same time is part of a blind-spot monitoring system. Such a monitoring system, known per se, is used for monitoring the traffic conditions surrounding the vehicle 1, in particular a region to the side of the vehicle 1 which allows poor visibility via the wing mirrors for overtaking or recently overtaken vehicles, and for generating a warning signal, in case the presence of such a vehicle would make lane changing dangerous.

As an alternative to the environmental sensor 13, a camera oriented in the lateral direction could be considered; given a sufficiently large viewing angle the camera 12 itself could even assume the function of the environmental sensor 13.

A user interface 14, here for example, a touch screen, allows the driver to control the functioning of the parking assistance system, or allows the processing unit 11 to display processing results to the driver.

In one simple configuration the activity of the processing unit 11 is limited to identifying empty spaces in the area around the vehicle 1, assessing their suitability as parking spaces for the vehicle 1 and displaying the result to the driver via the user interface 14. According to an enhanced configuration, the processing unit 11 can also be connected to a steering wheel actuator 15, brakes 16, and engine and transmission controllers 17, 18, in order to maneuver the vehicle autonomously into this parking space 1 if the driver issues a parallel parking command via the user interface 14 after identifying an empty space suitable as a parking space.

FIG. 3 shows a flowchart illustrating an operating procedure which, started by an input by the driver on the user interface 14 in step S1, is performed by the processing unit 11 while the vehicle 1 travels along the road 2 searching for a parking space. Each time, if in doing so it has passed one of the parked vehicles 6, in step S2 the environmental sensor 13 records in passing the beginning of an empty space 19 between two vehicles 6.

While the vehicle 1 continues driving, the processing unit 11 continuously uses the signals from the environmental sensor 13 to monitor whether an end of the empty space 7 has been reached (step S3). In the case of the empty spaces 19, the rear of a nearest parked vehicle 6 is detected after a distance which is shorter than the length of the vehicle 1. These spaces 19 are therefore deemed to be unsuitable for parking, and the method returns to step S2 in order to await the next empty space to be found.

If, on the other hand (in the case of empty space 7) no end of the empty space is detected, in step S4 a check is made whether the length of road required for parking has been travelled since the beginning of the empty space. If this is not the case, then the method returns to step S3, while the vehicle 1 continues driving.

However, as soon as the necessary length has been driven and the empty space is therefore deemed long enough for parallel parking 7, in step S5 the processing unit 11 checks, based on the image supplied by camera 12, whether a traffic sign indicating an intersection or junction exists on the road 2. In particular, such a traffic sign can be the traffic light 5, but also for example the traffic signs with numbers 102, 205, 206, 214, 215 of the German Road Traffic Regulations. Road lane markings, such as a stop line 20 (see FIG. 1) crossing the lane in front of the vehicle 1, can also be regarded as traffic signs to be detected. If no such traffic sign is found, in step S6 the processing unit 11 displays a signal to the driver on the user interface 14 that the empty space which has been found is suitable as a parking space. The driver can then park by him/herself, or if the processing unit 11 supports autonomous parallel parking, issue the parallel parking command.

If, on the other hand, a traffic sign is found in step S5, then this is followed in step S7 by a measurement of its distance from the vehicle 1.

In step S8 it is checked whether this measured distance, plus the path length 7 driven since reaching the beginning of the empty space in step S2, and minus the length of the vehicle 1 itself and of a safe distance from a vehicle 6 parked behind it, is greater than the distance from the intersection 3 prescribed under the Traffic Regulations. If this is not the case, then the empty space 7 is not suitable for parking and the method returns to step S2. Otherwise parking is possible, and the processing unit 11 displays a message to this effect to the driver on the user interface 14. The driver must now (S9) decide whether he wants to use the parking space or not. Driving past the parking space causes the method to return to S2.

If he does want to use the parking space, he will in general drive the vehicle 1 far enough forward as is necessary for safely reversing into the gap (S10) and then select reverse gear (S11). Thereupon, the processing unit 11 again initiates in step S12 a measurement of the distance to the traffic sign and decides in step S13 whether the specified distance to the junction 3 is observed. If not, a warning is displayed on the user interface 14 that parking is still not allowed in the currently achieved position (S14). While the driver then reverses the vehicle 1, the processing unit 11 repeats the steps S12, S13, until it is finally established that the required distance from the intersection is observed, whereupon the warning signal is switched off in step S15. A permissible parking position is therefore reached, and the vehicle 1 can be stopped.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-9. (canceled)

10. A parking assistance system for a vehicle comprising a processor configured to detect an empty space adjacent to a vehicle, assess the suitability of the empty space as a parking space for the vehicle, and estimate a distance between the empty space and an intersection using image data from a camera associate with the vehicle.

11. The parking assistance system according to claim 10, further comprising an image analysis unit to detect a traffic indicator indicative of the intersection and estimate the distance between the vehicle and the traffic sign.

12. The parking assistance system according to claim 11 wherein the traffic indicator is selected from the group consisting of a traffic light, a Right of Way sign, a Yield sign, a Stop sign, a stop line and combinations thereof.

13. The parking assistance system according to claim 1 further comprising a warning signal emitter to generate a warning signal when the estimated distance is less than a limit value.

14. A method for assess the suitability of an empty space as a parking space for a vehicle comprising:
(a) identifying a roadside space;
(b) capturing image data of the roadside space with a camera associated with a vehicle;
(c) estimating a distance between the roadside space and an intersection using the image data;
(d) rejecting the roadside space as a suitable parking space when the estimated distance is less than a predefined limit; and
(e) accepting the roadside space as the suitable parking space when the estimated distance is greater than or equal to the predefined limit.

15. The method according to claim 14 further comprising capturing image data of a traffic indicator indicative of an intersection, estimating an indicator distance from the roadside space to the traffic indicator and equating the indicator distance with the estimated distance.

16. The method according to claim 14 further comprising monitoring a parking distance between the vehicle and the intersection during a parking maneuver and generating an alarm when the parking distance is less than a predefined parking limit.

17. A non-transitory computer readable medium containing a computer program configured to make a processor execute a method comprising:
(a) identifying a roadside space;
(b) capturing image data of the roadside space with a camera associated with a vehicle;
(c) estimating a distance between the roadside space and an intersection using the image data;
(d) rejecting the roadside space as a suitable parking space when the estimated distance is less than a predefined limit; and
(e) accepting the roadside space as the suitable parking space when the estimated distance is greater than or equal to the predefined limit.

18. The non-transitory computer readable medium of claim 17, wherein the computer program is configured to make the processor further execute the method comprising capturing image data of a traffic indicator indicative of an intersection, estimating an indicator distance from the roadside space to the traffic indicator and equating the indicator distance with the estimated distance.

19. The non-transitory computer readable medium of claim 17, wherein the computer program is configured to make the processor further execute the method comprising monitoring a parking distance between the vehicle and the intersection during a parking maneuver and generating an alarm when the parking distance is less than a predefined parking limit.
